(19) United States
(12) Patent Application Publication
(10) Pub. No.: US 2016/0169123 A1
(43) Pub. Date: Jun. 16, 2016

(54) HIGH PRESSURE FUEL SUPPLYING APPARATUS OF ENGINE

(71) Applicants: Hyundai Motor Europe Technical Center GmbH, Russelsheim (DE); Hyundai Motor Company, Seoul (KR); Kia Motors Corp., Seoul (KR)

(72) Inventors: Stephan Fitzner, Echzell (DE); Ulrich Karrer, Mainz (DE)

(73) Assignees: Hyundai Motor Europe Technical Center GmbH, Russelsheim (DE); Hyundai Motor Company, Seoul (KR); Kia Motors Corp., Seoul (KR)

(21) Appl. No.: 14/744,503

(22) Filed: Jun. 19, 2015

(30) Foreign Application Priority Data
Dec. 10, 2014 (KR) 10-2014-0177717

(51) Int. Cl. F02D 13/02

(52) U.S. Cl. CPC F02D 13/0203

(57) ABSTRACT

A high pressure fuel supplying apparatus of an engine may include a chain case configured to enclose a chain which transfers power from a crankshaft of the engine to a valve camshaft, a pump housing part integrated with the chain case, and a pumping rotating body directly driven by the chain and forming a reciprocating linear displacement within the pump housing part.

### CROSS REFERENCE TO RELATED APPLICATION

The present application claims priority to Korean Patent Application Number 10-2014-0177717 filed Dec. 10, 2014, the entire contents of which is incorporated herein for all purposes by this reference.

### BACKGROUND OF THE INVENTION

1. Field of the Invention

The present invention relates to a high pressure fuel supplying apparatus of an engine which is an internal combustion engine.

2. Description of Related Art

A high pressure fuel supplying apparatus of an engine serves to again high-pressure pump fuel, which is supplied from a fuel tank by a low pressure pump and supply the pumped fuel to the engine and is configured to be mainly mounted in the engine so as to interlock with an operation of the engine and supplied with power from the engine.

The existing high pressure fuel supplying apparatus is mainly configured to operate a high pressure pump separately mounted in an engine block, interlocking with a power transfer means such as a camshaft, a gear, and a chain from a crankshaft, a belt, or the like for the engine.

Therefore, a separate pump housing configuring the high pressure pump is mounted at a side of the engine block, a separate part such as the camshaft transferring power from the engine to the pump housing so as to supply power interlocking with a rotation of the engine to the pump housing is required, and the pump housing is provided with a pump which high-pressure pumps fuel using the power transferred as described above.

The existing high pressure fuel supplying apparatus including the separate pump housing which is mounted in the engine block as described above has a relatively heavy weight to adversely affect fuel efficiency of a vehicle and requires a separate part for transferring power synchronized with the engine to the pump housing to have a complicated structure and a relatively large volume.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a high pressure supplying apparatus of an engine capable of making mountability in a vehicle good by more compactly configuring an engine to have a relatively smaller volume, improving fuel efficiency of the vehicle by reducing a weight and the number of required parts, and providing smooth operability and long durability.

According to various aspects of the present invention, a high pressure fuel supplying apparatus of an engine may include a chain case enclosing a chain which transfers power from a crankshaft of the engine to a valve camshaft, a pump housing part integrated with the chain case, and a pumping rotating body directly driven by the chain and forming a reciprocating linear displacement within the pump housing part.

The pumping rotating body may include a sprocket part coupled to the chain, a cam part rotating by a rotation of the sprocket part, and a hollow part integrally connecting the sprocket part with the cam part.

The chain case may include a front case enclosing the chain from a front side of an engine block, a rear case configured to position the chain in a space sealed from the front case while enclosing the chain from an opposite side of the front case based on the chain, and a support shaft configured to have one end fixed to the front case and another end fixed to the rear case to rotatably support an inner side of the hollow part of the pumping rotating body.

Rolling bearings may be mounted in at least two places between the support shaft and the hollow part of the pumping rotating body to support a rotation of the pumping rotating body.

The pump housing part may be provided with a unit pump including a plunger which linearly reciprocates, interlocking with the cam part of the pumping rotating body to pump fuel.

The chain transferring power driving the valve camshaft from the crankshaft of the engine is directly coupled to the sprocket part and the reciprocating linear displacement required for high-pressure pumping of fuel while the cam part directly connected to the hollow part rotates is formed in the sprocket part.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating a chain case in which an exemplary high pressure fuel supplying apparatus of an engine according to the present invention is mounted.

FIG. 2 is a cutaway view of main parts of the present invention in a state in which the chain case of FIG. 1 is coupled to the engine.

FIG. 3 is a diagram illustrating only some of the main parts in the configuration of FIG. 1.

FIG. 4 is a cross-sectional view taken along the line IV-IV of FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

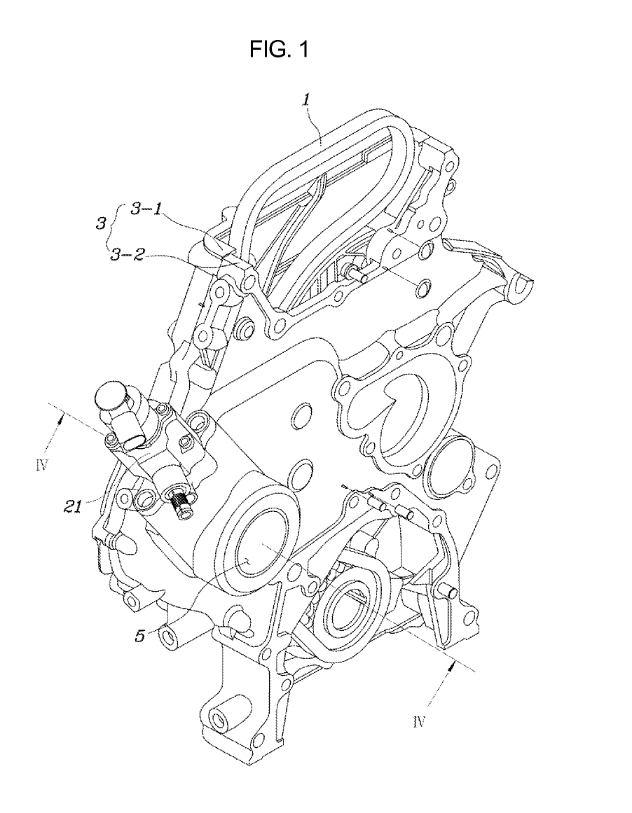

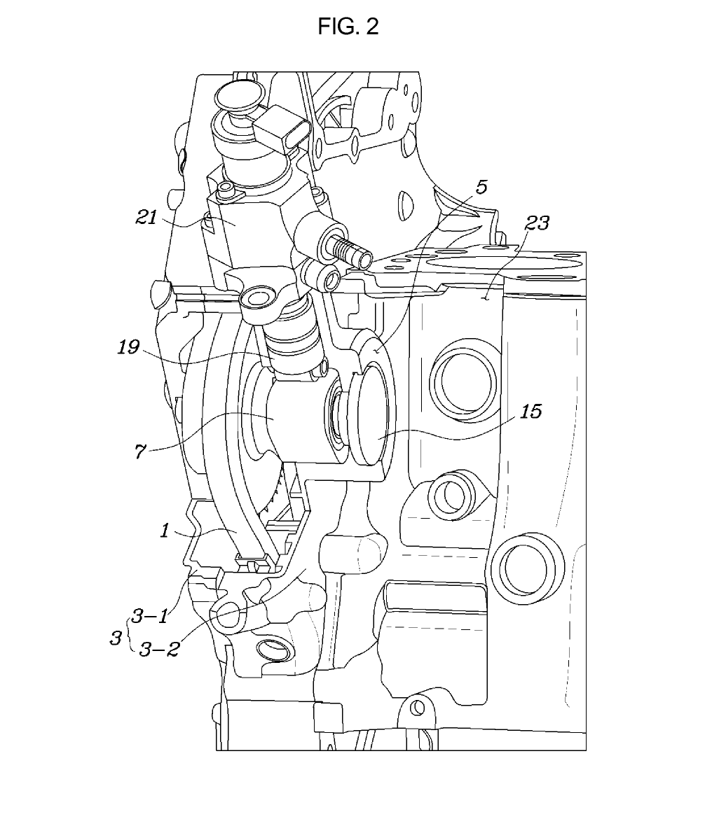

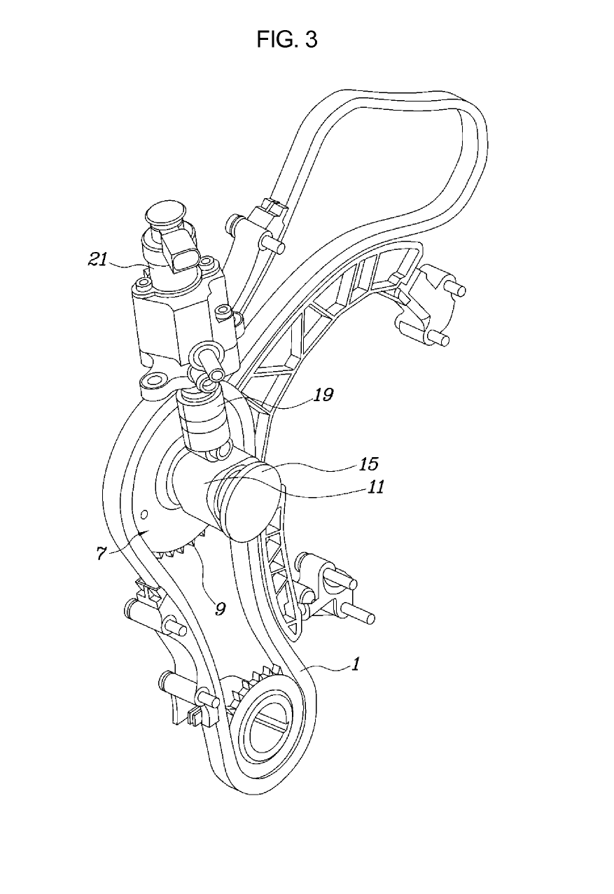

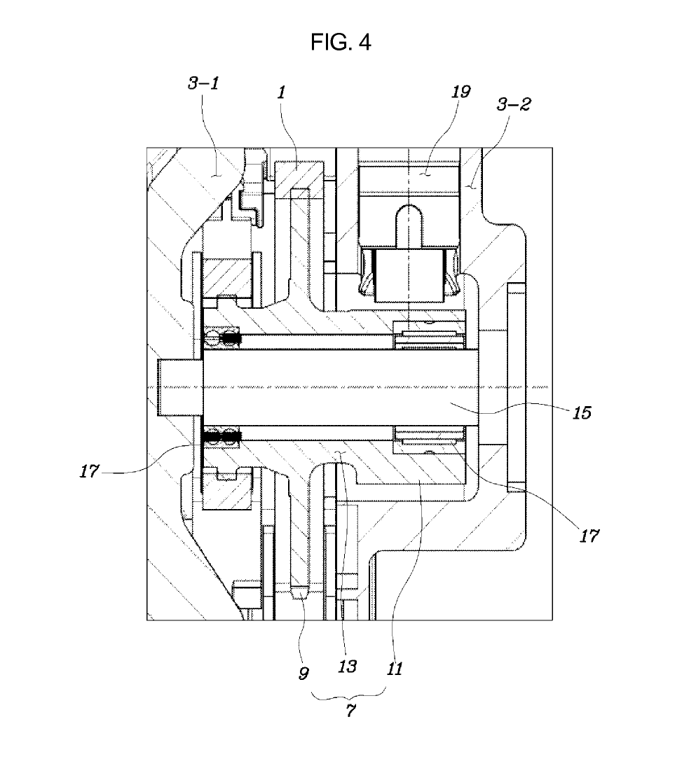

Referring to FIG. 1, FIG. 2, FIG. 3 and FIG. 4, a high pressure fuel supplying apparatus of an engine according to various embodiments of the present invention includes a chain case 3 configured to enclose a chain 1 which transfers power from a crankshaft for the engine to a valve camshaft, a pump housing part 5 configured to be integrated with the chain case 3, and a pumping rotating body 7 configured to be directly driven by the chain and form a reciprocating linear displacement within the pump housing part 5.

That is, as compared with the case in which the separate pump housing is mounted, a chain case 3 of the engine according to various embodiments of the present invention is, integrated with the pump housing part 5 which high-pressure pumps fuel, and thus the engine has a reduced volume and weight to be more compactly configured, thereby improving fuel efficiency of a vehicle.

The pumping rotating body 7 includes a sprocket part 9 configured to be coupled with the chain 1, a cam part 11 configured to rotate by a rotation of the sprocket part 9, and a hollow part 13 which is the hollow shaft configured to integrally connect the sprocket part 9 with the cam part 11.

That is, according to the related art, to provide power required to pump fuel at a high pressure from the engine, a pumping cam mounted in a separate housing is driven by taking-off power from the engine by a power transfer device such as a separate camshaft, a gear, and a belt. However, according to various embodiments of the present invention, the chain 1 transferring power driving the valve camshaft from the engine crankshaft may be directly coupled with the sprocket part 9 and the reciprocating linear displacement required for the high-pressure pumping of fuel while the cam part 11 directly connected to the hollow part 13 rotates may be formed in the sprocket part 9, thereby reducing the number of parts required for the high-pressure pumping of fuel, reducing the weight and the volume, and providing the high-pressure pumping of fuel with the compact structure.

According to various embodiments of the present invention, the chain case 3 includes a front case 3-1 configured to enclose the chain 1 from a front side of the engine block 23, a rear case 3-2 configured to position the chain 1 in a space sealed from the front case 3-1 while enclosing the chain 1 from an opposite side of the front case 3-1 based on the chain 1, and a support shaft 15 configured to have one end fixed to the front case 3-1 and the other end fixed to the rear case 3-2 to rotatably support an inner side of the hollow part 13 of the pumping rotating body 7.

Further, rolling bearings 17 are mounted in at least two places between the support shaft 15 and the hollow part 13 of the pumping rotating body 7 to support the rotation of the pumping rotating body 7.

That is, the pumping rotating body 7 is rotatably supported to the chain case 3 by the support shaft 15 and is supported by the rolling bearing 17, and thus the pumping rotating body 7 may more smoothly and softly rotate and may have improved durability.

Further, as the rolling bearing 17, a roller bearing, a needle bearing, or the like may be used and the rolling bearings 17 are each mounted at both sides of the pumping rotating body 7 and thus may be configured to firmly support the pumping rotating body 7 to the support shaft 15.

According to various embodiments of the present invention, the pump housing part 5 is integrally formed at the rear case 3-2 and the pump housing part 5 is provided with a unit pump 21 configured to include a plunger 19 which linearly reciprocates, interlocking with the cam part 11 of the rotating pumping rotating body 7 to pump fuel.

That is, the plunger 19 is inserted into the pump housing part 5 to fix the unit pump 21 to the pump housing part 5 in the state in which the plunger 19 contacts the cam part 11 and the unit pump 21 serves to high-pressure pump fuel therein by the reciprocating linear motion provided through the cam part 11 and the plunger 19.

The pump housing part 5 and the unit pump 21 may be positioned at any place which may be transferred with power from the chain 1, and therefore the position thereof may be relatively freely selected to improve the freedom of design of the engine, thereby more compactly configuring the engine.

Further, according to various embodiments of the present invention, the number of parts and the volume which are required to configure the high pressure fuel supplying apparatus may be remarkably reduced, and as a result, costs required to manufacture the vehicle may be reduced and the fuel efficiency of the vehicle may be improved.

Further, the pumping rotating body 7 may be configured to perform the high-pressure pumping of fuel by the simpler power transfer method and the pumping rotating body 7 may be configured to be supported by the rolling bearing 17 to perform the more smoothing operation, thereby greatly improving the overall durability.

According to various embodiments of the present invention, it is possible to make the mountability in the vehicle good by more compactly configuring the engine to have the relatively smaller volume, improve the fuel efficiency of the vehicle by reducing the weight and the number of required parts, and provide the smooth operability and the long durability.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A high pressure fuel supplying apparatus of an engine, comprising:
a chain case enclosing a chain which transfers power from a crankshaft of the engine to a valve camshaft;
a pump housing part integrated with the chain case; and
a pumping rotating body directly driven by the chain and forming a reciprocating linear displacement within the pump housing part.

2. The high pressure fuel supplying apparatus of the engine of claim 1, wherein the pumping rotating body includes:
a sprocket part coupled to the chain;
a cam part rotating by a rotation of the sprocket part; and
a hollow part integrally connecting the sprocket part with the cam part.

3. The high pressure fuel supplying apparatus of the engine of claim 2, wherein the chain case includes:
a front case enclosing the chain from a front side of an engine block;
a rear case positioning the chain in a space sealed from the front case while enclosing the chain from an opposite side of the front case based on the chain; and
a support shaft having a first end fixed to the front case and a second end fixed to the rear case to rotatably support an inner side of the hollow part of the pumping rotating body.

4. The high pressure fuel supplying apparatus of the engine of claim 3, wherein rolling bearings are mounted in at least two places between the support shaft and the hollow part of the pumping rotating body to support a rotation of the pumping rotating body.

5. The high pressure fuel supplying apparatus of the engine of claim 2, wherein the pump housing part is provided with a unit pump including a plunger which linearly reciprocates, interlocking with the cam part of the pumping rotating body to pump fuel.

6. The high pressure fuel supplying apparatus of the engine of claim 2, wherein the chain transferring power driving the valve camshaft from the crankshaft of the engine is directly coupled to the sprocket part and the reciprocating linear displacement required for high-pressure pumping of fuel while the cam part directly connected to the hollow part rotates is formed in the sprocket part.
